(19) United States
(12) Patent Application Publication
(10) Pub. No.: US 2009/0259864 A1
(43) Pub. Date: Oct. 15, 2009

(54) SYSTEM AND METHOD FOR INPUT/OUTPUT CONTROL DURING POWER DOWN MODE

(75) Inventors: Alan Li, San Jose, CA (US); Shifeng Yu, Fremont, CA (US)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA CORPORATION, Santa Clara, CA (US)

(21) Appl. No.: 12/101,059

(22) Filed: Apr. 10, 2008

(51) Int. Cl. G06F 1/00

(52) U.S. Cl. 713/323; 713/320

(57) ABSTRACT

A system and method for maintaining values on output pads of an integrated circuit during entry, exit, and while a portion of the integrated circuit is in a power conservation or deep power down mode. The method for entering a power conservation mode includes determining a power conservation mode value which will be maintained at an output pad while a portion of an integrated circuit is in a power conservation mode. The power conservation mode value may then be selected for output and the power conservation mode value is held at the output pad. The portion of the integrated circuit to enter the power conservation mode is then electrically decoupled from the output pad. The portion of the integrated circuit may then be placed in the power conservation mode without output signal slighting while maintaining the output value.

### FIELD OF THE INVENTION

Embodiments of the present invention are generally related to circuitry for controlling input/outputs of integrated circuits.

### BACKGROUND OF THE INVENTION

As integrated circuit design has advanced, integrated circuits have become smaller, faster, and more powerful. As a result, power usage has correspondingly increased and become increasingly important. Power consumption in mobile devices is particularly important. In order to conserve power, conventional integrated circuits go into a complete power off mode where the outputs and inputs are turned off as well. This power off mode allows the integrated circuit to be turned off and thereby conserve power until the functionality of the integrated circuit is needed.

Unfortunately, upon resuming from the power off mode peripherals connected to the integrated circuit must be reinitialized before the peripherals can be used. The reinitialization of peripherals and integrated circuits results in delays during which the device containing the peripheral and integrated circuit is unresponsive. These delays may result in a poor user experience as the user waits for the device to resume or boot from the power off mode. The delays thus cause the device to be slow in responding upon power up.

### SUMMARY OF THE INVENTION

Accordingly, what is needed is a solution for an integrated circuit to conserve power by entering a low power mode while maintaining its output signals to attached peripherals. Further, what is needed is a solution for entering and exiting the low power mode without glitching the outputs of the integrated circuit. Embodiments of the present invention provide a solution for maintaining output signals of input/output pins of an integrated circuit core while portions of the integrated circuit enter, stay in, and exit a low power state. Embodiments of the present invention further allow for entry and exit of the low power state without glitches or fluctuations on the output signals.

In one embodiment, the present invention is implemented as a method for entering a power conservation mode. The method for entering a power conservation mode includes determining a power conservation mode value which will be maintained at an output pad (e.g., general purpose input/output (GPIO)) while a portion of an integrated circuit (e.g., core of an SoC) is in a power conservation mode. The power conservation mode value may then be selected for output and the power conservation mode value is held at the output pad. The portion of the integrated circuit to enter the power conservation mode is then electrically decoupled (e.g., via a pass gate) from the circuitry holding the output signal at the output pad. The power conservation mode in the portion of the integrated circuit may then be invoked. The holding of the value at the output along with the electrical decoupling prevents glitching on the output pad. It is appreciated that the output pad and the portion of the integrated circuit which enters the power conservation mode may operate at different voltages and be in different power domains (e.g., be coupled to separate power supply rails).

In another embodiment, the present invention is implemented as a method for exiting a power conservation mode. The method for exiting a power conservation mode includes invoking a powered up mode of a portion of an integrated circuit (e.g., the core of a system on a chip) and selecting a value from the portion of the integrated circuit. The portion of the integrated circuit may then be electrically coupled (e.g., via a pass gate) to an output pad which allows the value from the portion of said integrated circuit to be output via the output pad. The output pad and the portion of the integrated circuit which exits the power conservation mode may operate at different voltages and be in different power domains (e.g., be coupled to different power supply rails). The integrated circuit may then continue normal operations which were suspended when the power conservation mode was entered.

In this manner, embodiments of the present invention facilitate driving and maintenance of output values while portions of an integrated circuit are put into power conservation or deep power down (DPD) mode. Embodiments of the present invention further maintain output signals without glitching while the DPD mode is entered, maintained, and exited.

In another embodiment, the present invention is implemented as a programmable system on a chip (SoC). The SoC includes a plurality of output pins which are coupled a plurality of drivers respectively. Each driver includes a pull up circuit coupled to each respective output and a pull down circuit coupled to each respective output. The SoC further includes a plurality of keeper circuits coupled to each respective pull up circuit and each respective pull down circuit for maintaining an output signal during power down. Each pull up circuit and pull down circuit is also coupled to a respective level shifter circuit for electrically coupling and decoupling a portion of the SoC to/from each of the plurality of outputs and also for providing different voltage domains between the signal being driven out and the core voltage. The level shifter circuits are controlled by a respective level shifter control circuit which controls the electrical coupling and decoupling of the level shifters. The level shifters are coupled to each of a plurality output selection circuits for selecting an output signal.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary integrated circuit architecture in accordance with one embodiment of the present invention.

FIG. 2 shows a block diagram of an exemplary system for maintaining output signals upon a core circuit entering and exiting a power conservation mode in accordance with one embodiment of the present invention.

FIG. 3 shows an exemplary circuit diagram for a level shifter circuit in accordance with one embodiment of the present invention.

FIG. 4 shows exemplary circuit diagram for a level shifter control circuit in accordance with one embodiment of the present invention.

FIG. 5 shows an exemplary timing diagram for maintaining output signals upon a core circuit entering and exiting a power conservation mode in accordance with one embodiment of the present invention.

FIG. 6 shows a flowchart of a process for entering a power conservation mode in accordance with one embodiment of the present invention.

FIG. 7 shows a flowchart of a process for exiting a power conservation mode in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

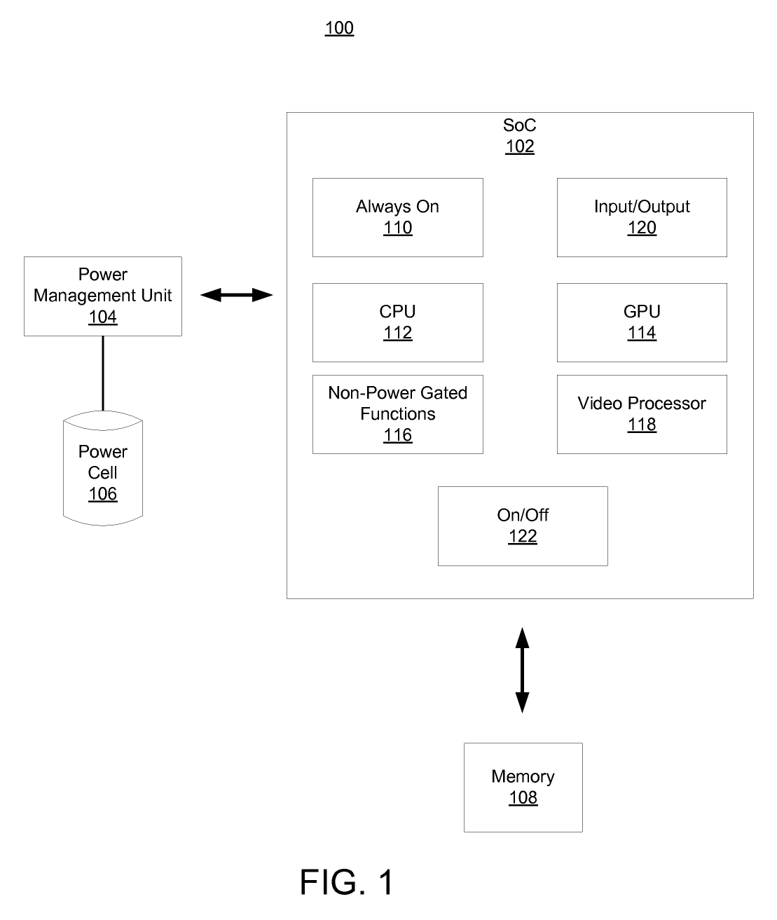

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of an integrated circuit (e.g., system on a chip 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### System Architecture:

Although embodiments of the present invention may be applied to any integrated circuit, FIG. 1 shows an exemplary integrated circuit architecture in accordance with one embodiment of the present invention. Integrated circuit architecture 100 includes system on a chip (SoC) 102, external power management unit (PMU) 104, power cell 106, and memory 108. SoC 102 includes always on module 110, central processor unit (CPU) 112, graphics processing unit (GPU) 114, non-power gated functions 116, video processor 118, input/output (I/O) module 120, and on/off module 122.

Integrated circuit architecture 100 depicts the components of a basic system in accordance with embodiments of the present invention providing the execution platform for certain hardware-based and software-based functionality. Video processor 118 performs a variety of video related functions including, but not limited to, encoding, decoding, and re-encoding of video. Non-power gated functions 116 may be put into a sleep state but also remain powered while other portions of SoC 102 are put into a sleep state. Non-power gated functions 116 can provide functionality to facilitate real time responsiveness of a device.

The CPU 112 can access memory 108 via a bridge component/memory controller (not shown) or can be directly coupled to the memory 108 via a memory controller (not shown) internal to the CPU 112. Memory 108 facilitates storage of component (e.g., context information), application, and operating system information for SoC 102. For example, memory 108 may be used to store context information and other information when portions of SoC 102 enter low power or sleep states.

Power cell 106 provides power to integrated circuit architecture 100. Power cell 106 may be a variety of power sources including, but not limited to, batteries, electrical sockets, and the like.

PMU 104 provides and regulates power to SoC 102. In one embodiment, PMU 104 provides power to SoC 102 via voltage rails (not shown) coupled to select groups of components. For example, PMU 104 may provide power to always on module 110 and I/O module 120 via an always on voltage rail and provide power to the rest of SoC 102 via a main voltage rail.

In one embodiment, always on (AO) module 110 is a power partition or domain which remains powered while other portions of SoC 102 may be placed into a deep power down (DPD) mode or low power state. Always on module 110 may thus facilitate portions of SoC 102 (e.g., CPU 112, GPU 114, video processor 118, and non-powered gated functions 116) entering and leaving sleep or low power states. Always on module 110 may include resources (e.g., registers and the like) for storing information to facilitate portions of SoC 102 going into a sleep state. AO module 110 may further include circuitry needed to maintain the higher level circuits that stay on during DPD mode. Always on module 110 may also power the minimum circuitry that will stay enabled through DPD mode and circuitry needed to support the input/output (I/O) circuitry.

On/off domain 122 is a power partition or domain for the core of SoC 102 (e.g., CPU 112, GPU 114, video processor 118) and includes functions and circuits for regular operations which do not need to be maintained during DPD mode. In one embodiment, the core operates in a voltage range of 1-1.2V, but could operate at any of a variety of well known voltage levels.

Input/Output (I/O) module 120 is a power domain which remains powered while other portions of SoC 102 are put into DPD mode. In accordance with embodiments of the present invention, input/output module 120 further maintains output values while portions of SoC 102 are put into DPD mode. I/O module 120 thereby facilitates SoC 102 entering DPD mode without requiring reinitialization of devices, circuits, and peripherals coupled to SoC 102 when SoC 102 exits DPD mode. In one embodiment, I/O module 120 may include I/O pads on the periphery of SoC 102. I/O module 110 may step the core signals to 1.8/2.8/3.3V for output which then facilitates communication of SoC 102 with external devices. In one embodiment, AO module 110 and I/O module 120 may be coupled to one voltage or power supply rail while on/off module 122 is coupled to another power supply rail. The coupling of the on/off module 122 to different power rail facilitates putting on/off module 122 into a deep power down mode.

Integrated circuit architecture 100 can be implemented as, for example, a portable device or hand held device including, but not limited to, cellular telephone, personal digital assistant (PDA), smartphone, audio player (e.g., MP3 player), remote control device, video player, and the like. In such an embodiment, components can be included that add peripheral buses, specialized audio/video components, I/O devices, and the like. These I/O devices may have driver circuits. Embodiments of the present invention, as discussed more fully herein are pertinent to these driver circuits.

More specifically, embodiments of the present invention facilitate driving and maintaining output signals while portions of the integrated circuit are put into low power mode (e.g., DPD) mode. Embodiments of the present invention further maintain the output signals without glitching while the DPD mode is entered, maintained, and exited.

Driver Circuits in Accordance with an Embodiment of the Present Invention

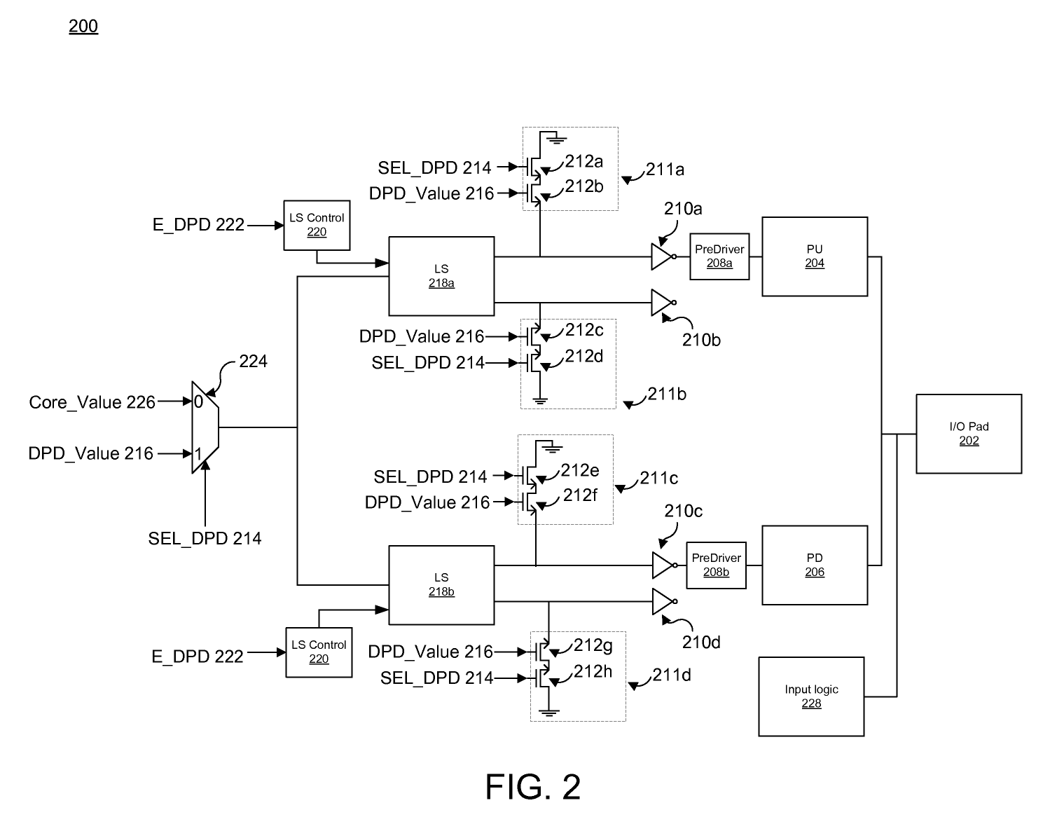

FIG. 2 illustrates example components used by various embodiments of the present invention. Although specific components are disclosed in system 200, it should be appreciated that such components are examples. That is, embodiments of the present invention are well suited to having various other components or variations of the components recited in system 200. It is appreciated that the components in system 200 may operate with other components than those presented, and that not all of the components of system 200 may be required to achieve the goals of system 200.

FIG. 2 shows a block diagram of an exemplary system for maintaining output signals while a core circuit enters and exits a power conservation mode in accordance with one embodiment of the present invention. System 200 includes input/output (I/O) pad 202, pull up circuit 204, pull down circuit 206, input logic 228, predrivers 208a and 208b, inverters 210a, 210b, 210c, and 210d, keeper circuits 211a, 211b, 211c, and 211d, level shifters 218a and 218b, level shifter control circuit 220, and multiplexer 224. Embodiments can be used in any situation where an I/O signal needs to be maintained at a certain value when a portion of an integrated circuit (e.g., the core circuit) is put in a DPD mode. While in DPD mode or power conservation mode, input/output pad 202 may be programmable and be driven or maintained with a high (e.g., logical 1), low (logical 0), or tri-state (e.g., high impedance) value.

System 200 receives signals SEL_DPD 214, DPD_Value 216, E_DPD 222, and core_value 226. Signals SEL_DPD 214 and E_DPD 222 are used to signal that the core is to enter DPD mode. In one embodiment, registers in the AO domain (e.g., AO module 110) maintain DPD_value 216, SEL_DPD 214, and E_DPD 222 signals.

System 200 facilitates the entry, maintenance, and exiting of a deep power down (DPD) mode or minimum power state where output pins are still driven. During DPD, any I/O domain circuits which are not essential for driving a static value at I/O pad 202 are deactivated. For example, biasing circuits which derive power from the I/O domain (I/O module 120) are turned off because the biasing circuits are not required in DPD mode since I/O pad 202 will not be switching.

In one embodiment, the AO domain (e.g., AO module 110) is at the core level power (e.g., 1-1.2V for instance) and supplies logic which controls DPD mode related operations (e.g., entry, maintenance, and exit of DPD mode). For example, the gates of pull up circuit 204 and pull down circuit 206 may be in the AO domain and therefore can maintain an output value at I/O pad 202 during a power down mode.

Pull up circuit 204 and pull down circuit 208 drive the output via I/O pad 202. In one embodiment, pull up circuit 204 and pull down circuit 208 may include thick oxide gates and may be implemented in accordance with well know techniques and structures. I/O pad 202 may be a general purpose input output (GPIO).

Multiplexer 224 receives input from core_value 226 which originates from the core logic and DPD_value 216. It is appreciated that multiplexer 224 may be substituted for any type of input selection circuit. Multiplexer 224 may operate in a power domain (e.g., on/off module 122) different from I/O pad 202. Multiplexer 224 may further be coupled to level shifters 218a and 218b.

Core_value 226 is a signal from the core (e.g., CPU 112, GPU 114, and video processor 118) of an integrated circuit (e.g., SoC 102) to be output on I/O pad 202. In one embodiment, multiplexer 224 selects input based on SEL_DPD signal 214. DPD value 216 is sampled from the core_value 226 and which will be the value maintained in DPD mode. During DPD, the SEL_DPD signal 214 selects DPD_value 216 and the DPD_value 216 signal may then propagate to level shifters 218a and 218b which in turn drive the pull up circuit 204 and pull down circuit 206 according to DPD_value signal 216.

It is appreciated that to output a high signal at I/O pad 202, level shifter circuit 218a outputs a high while level shifter circuit 218b outputs a low. Likewise, to output a low at I/O pad 202, level shifter circuit 218a outputs a low and level shifter circuit 218b outputs a high. Tristate is enabled when both 218a and 218b output a low.

Level shifters 218a and 218b control driver circuits pull up circuit 204 and pull down circuit 206 which thereby drive the output on I/O pad 202. Level shifters 218a and 218b further avoid glitching on the output (e.g., I/O pad 202) by electrically coupling and decoupling a portion of an integrated circuit to/from the output during DPD mode and the transition to and from DPD mode. Level shifter 218a is coupled to keeper circuits 211a and 211b which include transistors 212a, 212b, 212c, and 212d, inverters 210a and 210b, predriver 208a, and pull up circuit 204. Level shifter 218b is coupled to keeper circuits 211c and 211d which include transistors 212e, 212f, 212g, and 212h, inverters 210c and 210d, predriver 208b, and pull down circuit 206. Level shifters 218a and 218b thus control the output of high, low, or tri-state at input/output pad 202. In addition to providing the electrical isolation discussed above, the level shifters also provide the require interface between the voltage domain of the core and the voltage domain at the I/O pin 202.

When I/O pad 202 is at tri-state, I/O pad 202 may be used to receive input via input logic 228 (e.g., logic for receiving input and a storage device or register). For example, the driving of tri-state at I/O pad 202 (e.g., by pull up circuit 204 and pull down circuit 206) allows a signal to be received, read, and the core to be woken up. When input/output 202 is used solely as an output, input logic 228 may be turned off to reduce power consumption.

Level shifters 218a and 218b prevent glitching on input/output pad 202 during entry and exit of an integrated circuit into a low power or deep power down mode. In one embodiment, level shifters 218a and 218b receive signals from multiplexer 224 and level shifter control circuit 220. Level shifters 218a and 218b may bridge power partitions (e.g., an on/off partition and an input/output power partition) and thereby facilitate the powering down of a partition (e.g., on/off partition 122) while maintaining output values on another partition (e.g., input/output partition 120). Thus, a portion of level shifters 218a and 218b may operate at one voltage domain (e.g., a core voltage of 1-1.2V) and another portion operates at another voltage domain (e.g., an output voltage of 1.8, 2.8, or 3.3V).

Predrivers 208a and 208b may be implemented using a number of well known structures and include logic and corresponding circuitry (e.g., fingers) which control the impedance and slough rate of pull up circuit 204 and pull down circuit 206 respectively. In one embodiment, pull up circuit 204 and pull down circuit 206 and predrivers 208a and 208b are in the I/O power domain or module 120.

Keeper circuits 211a, 211b, 211c, and 211d facilitate maintaining an output signal on input/output pad 202 while portions of system 200 and portions coupled thereto enter, stay in, and exit a deep power down mode and avoid glitching. Importantly, the keeper circuits maintain the output signal after the level shifters have decoupled the two voltage domains. Keeper circuits 211a, 211b, 211c, and 211d include transistors 212a, 212d, 212e, and 212h which receive signal SEL_DPD 214. Keeper circuits 211a, 211b, 211c, and 211d further include transistors 212b, 212c, 212f, and 212g which receive signal DPD_Value 216. Keeper circuits 211a, 211b, 211c, and 211d prevent the value on I/O pad 202 from floating and operate with the level shifter circuits to pull the value to hard high or hard low signal. Thus, keeper circuits 211a, 211b, 211c, and 211d maintain the output of level shifters 218a and 218b while an integrated circuit (e.g., SoC 102) is put into a DPD mode. The signal SEL_DPD 214 activates the keeper circuits during DPD mode and the signal DPD_value 216 informs the keeper circuit of the value to be maintained at the I/O pad 202 during this mode.

Level shifter control circuit 220 is coupled to level shifters 218a and 218b. Level shifter control circuit 220 receives signal E_DPD 222. Level shifter control circuit 220 controls the electrical coupling and decoupling of portions of level shifters 218a and 218b and thereby the electrical coupling of multiplexer 224 to all the circuitry to the right of the level shifters including I/O pad 202. In one embodiment, the electrical decoupling by level shifters 218a and 218b via transmission or pass gates blocks portions of a core or integrated circuit (e.g., SoC 102) from directly driving the outputs. The pass gates of level shifter 218a and 218b bridge the on/off domain and the I/O domain to isolate the I/O domain circuitry from the on/off domain and prevent leakage when on/off domain is powered down and assist in preventing glitches at the signal output.

Entering into DPD Mode

In one embodiment, AO circuitry sets up the value to drive at I/O pad 202 with signal DPD_value 216 by sampling core_value 226. The circuitry which generated the core_value 226 signal may later be powered down as the circuitry is no longer needed after the output at I/O pad is fixed.

When SEL_DPD 214 is asserted the signal DPD_value 216 is allowed to propagate to I/O pad 102 otherwise the core_value 226 is propagated. SEL_DPD 214 signal allows the DPD_value 216 to propagate though to input/output 202 in anticipation of power down and prevents signal fighting with regular operations and avoids glitching.

During the power down sequence, signal E_DPD 222 is next asserted. Signal E_DPD 222 may close the transmission gates of level shifters 218a and 218b to electrically decouple multiplexer 224 and I/O pad 202 thereby isolating the on/off domain logic from I/O pad 202 and its driver circuitry. Signal E_DPD 222 also allows the value at I/O pad 202 to be set and maintained (e.g., via keeper circuits 211a, 211b, 211c, and 211d) during DPD mode. The on/off portion of the circuit may be powered down just after the signal E_DPD 222 is asserted. For example, On/Off domain may include biasing devices used to drive high frequency signals which consume a significant amount of power and are accordingly turned off. Correspondingly, the power rail for the On/Off domain can be subsequently powered-down.

In one embodiment, glitches of the output signal are prevented by keeper circuits 211a, 211b, 211c, and 211d activating on signal DPD_value 216 and electrical isolation of the level shifters. The keeper circuits may be activated on DPD_Value 216 which has propagated though to the output of level shifters 218a and 218b and before the pass gates of the level shifters 218a and 218b are deactivated by level shifter control signal 220.

### Exiting DPD Mode

When exiting DPD mode, the core may be powered up and the pass gates of level shifters 218a and 218b are activated which allows DPD_Value 216 from multiplexer 224 to propagate though to the output of level shifters 218a and 218b. Keeper circuits 211a, 211b, 211c, and 211d are then deactivated. When SEL_DPD 214 signal is deactivated, core_value 226 is selected and allowed to propagate from multiplexer 224 to the output of the level shifters 218a and 218b. The integrated circuit may then resume regular operations (e.g., communication with peripherals and external integrated circuits).

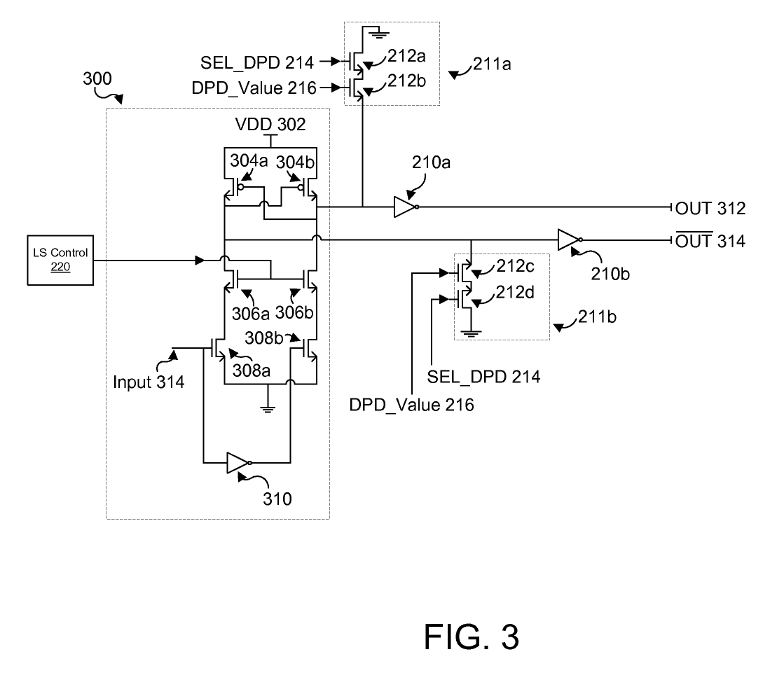

FIG. 3 shows an exemplary circuit diagram 300 for a level shifter in accordance with one embodiment of the present invention. Circuit 300 is an exemplary circuit implementation of a level shifter (e.g., level shifters 218a and 218b). It is appreciated that while circuit diagram 300 illustrates an exemplary circuit, embodiments of the present of invention are not intended to be limited as such and it is appreciated that the functionality of circuit diagram 300 may be implemented in a variety of ways. Circuit 300 includes cross coupled transistors 304a and 304b, pass gate transistors 306a and 306b, input transistors 308a and 308b, and inverter 310.

In one embodiment, circuit 300 is coupled to keeper circuits 211a and 211b, inverters 210a and 210b, and power supply voltage (VDD) 302. Circuit 300 receives signals via input 314 (from multiplexer 224, FIG. 2) and level shifter control circuit 220. Circuit 300 further receives signals SEL_DPD 214 and DPD_Value 216. Circuit 300 in conjunction with keeper circuits 211a and 211b and inverters 210a and 210b facilitate generating of signals out 312 and out bar 314. Signals out 312 and out bar 314 may be used control pull up and pull down circuits (e.g., pull up circuit 204 and pull down circuit 206 of FIG. 2) to maintain a signal on an output (e.g., I/O pad 202) during DPD mode.

Input 314 may receive signals from a core (e.g., core_value 226) or a DPD value signal (e.g., DPD_value 216) via a selection circuit (e.g., multiplexer 224). Depending on the signal received at input 314, input transistors 308a and 308b and inverter 310 pull one of the terminals of pass gate transistors 306a and 306b to ground to propagate the data value.

Pass gate transistors 306a and 306b are controlled by a signal from level shifter control circuit 220 and thereby electrically couple and decouple input transistors 308a and 308b from the rest of circuit 300. For example, when level shifter control circuit 220 generates a low signal pass gate transistors 306a and 306b are off and input transistors 308a and 308b are electrically decoupled from the outputs of circuit 300. When the level shifter control circuit 220 generates a high signal, pass gate transistors 306 are on and input transistors 308 are coupled to the outputs of circuit 300. Pass gate transistors 306 thus facilitate portions of an integrated circuit coupled to input 314 being powered down while the output of circuit 300 is maintained.

Cross coupled transistors 304a and 304b output at the I/O domain voltage based on the input data at input 314 during power on mode. Cross coupled transistors 304a and 304b in conjunction with keeper circuits 211a and 211b facilitate the maintenance of an output during DPD mode without glitching. Cross coupled transistors 304a and 304b further ensure that signals out 312 and out bar 314 are complementary.

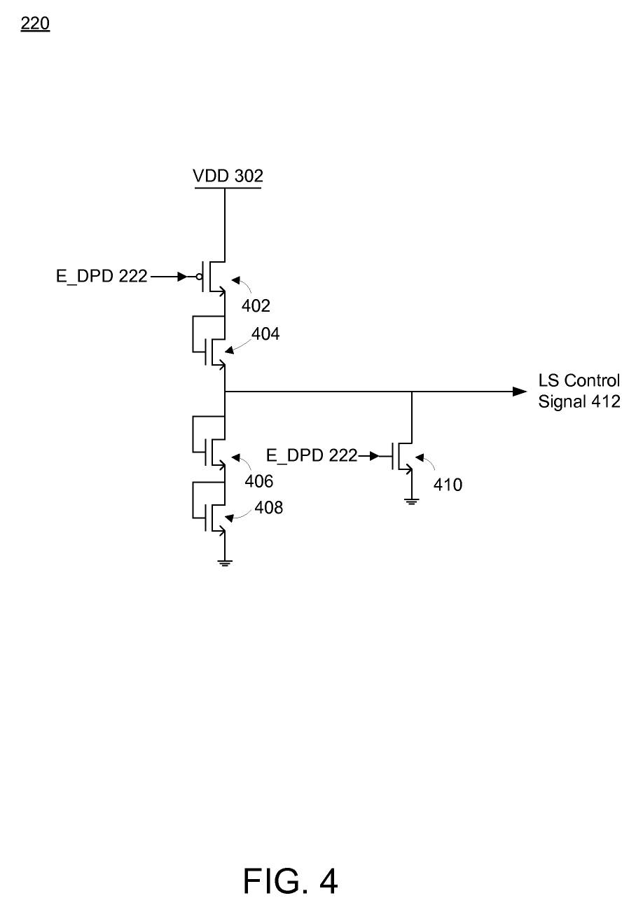

FIG. 4 shows exemplary circuit diagram for a level shifter control circuit 220 in accordance with one embodiment of the present invention. It is appreciated that while circuit diagram 220 illustrates an exemplary circuit, embodiments of the present of invention are not intended to be limited as such and it is appreciated that the functionality of circuit 220 may be implemented in a variety of ways. Circuit 400 includes transistors 402, 410, diode connected transistors 404-408, and power supply (VDD) 302. Circuit 220 receives signals E_DPD 222 and outputs level shifter control signal 412. In one embodiment, circuit 220 may draw a relatively large amount of DC current and portions may be turned off in DPD mode.

Transistor 402 is controlled by E_DPD signal 222 which when low results in the level shifter control signal 412 being high or VDD 302. In one embodiment, transistor 402 is a PMOS transistor. Level shifter control signal 412 being high enables the pass gates (e.g., pass gate transistors 306a and 306b) of the level shifters to allow input signals of the level shifters to propagate to the output of the level shifters (e.g., during normal operation of the circuit).

Conversely, when E_DPD signal 222 is high, transistor 410 is on which results in the level shifter control signal 412 being pulled down to ground while the remainder of circuit 220 may be deactivated since transistor 402 is off. Level shifter control signal 412 being low deactivates the pass gates (e.g., pass gate transistors 306a and 306b). Correspondingly, the deactivations of the pass gates of the level shifters results in the electrical decoupling of the input portion of a level shifter from the outputs of the level shifter. Thus, after the DPD mode value to be held at the output (e.g., DPD_value 216) has propagated to the outputs of the level shifters (e.g., level shifters 218a and 218b) and clamped by keeper circuits (e.g., keeper circuits 211a and 211b), E_DPD signal 222 may be asserted (e.g., set to high) and the inputs of the level shifters are electrically decoupled from the outputs of the level shifters.

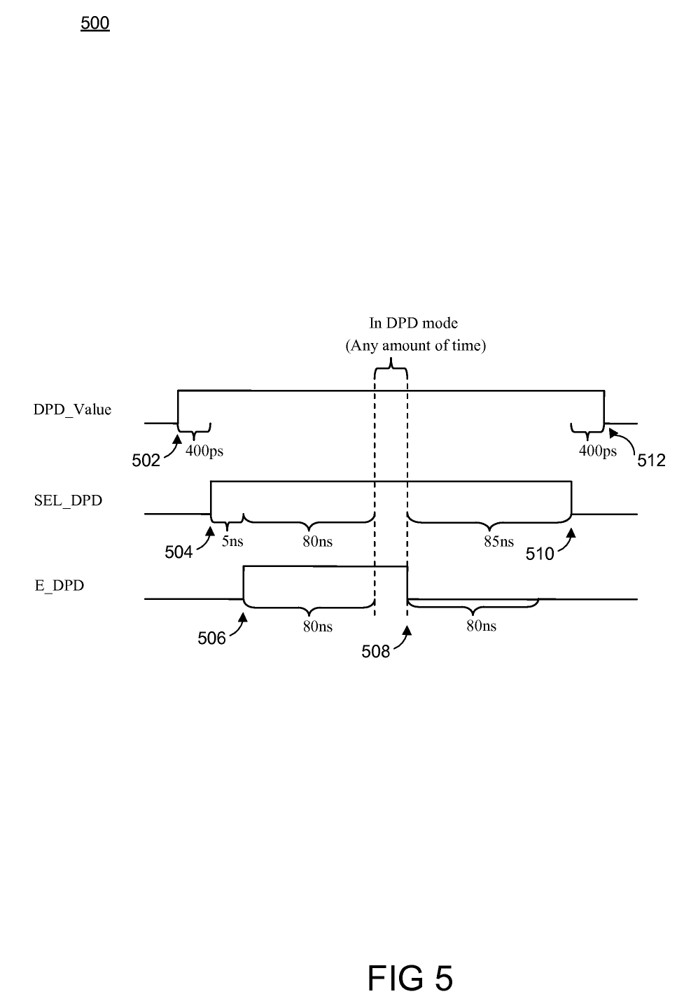

FIG. 5 shows an exemplary timing diagram for entering and exiting a power conservation mode in accordance with one embodiment of the present invention. It is appreciated that while FIG. 5 mentions time lengths, the time lengths are exemplary and as such not intended to be limiting.

At time 502, the DPD_value signal is asserted. The DPD_value may be a value to be driven at an output of an integrated circuit (e.g., DPD_value signal 216) during DPD mode and is merely a simultaneous sample of the core_value 226 (FIG. 2). It is appreciated that the DPD_value 216 is maintained by the AO circuits.

At time 504, the SEL_DPD signal is asserted. As described herein, the SEL_DPD signal (e.g., SEL_DPD signal 214) switches the input signal that the outputs of the integrated circuit are coupled to and allows the DPD_value signal to propagate to the output circuits before the E_DPD signal is asserted. For example, after SEL_DPD is asserted, multiplexer 224 starts to pass the DPD_value signal which propagates to the outputs of the level shifters and eventually to I/O pad 202. The DPD_value signal then arrives that at keeper circuits where the DPD_value signal may be maintained during DPD mode.

At block 506, after the DPD_value has fully propagated to the I/O pad 202, the E_DPD signal is asserted. As described herein, the E_DPD signal (e.g., E_DPD signal 222) electrically decouples the inputs of the level shifters from the outputs of the level shifters. The E_DPD signal thereby facilitates the entry of a portion of an integrated circuit into a DPD mode while outputs of the integrated circuit are maintained. During DPD mode, the E_DPD, SEL_DPD, and DPD_value signals remain asserted as well as the output signal on I/O pad 202.

FIG. 5 also illustrates timing signals for exiting DPD mode. At time 508, the E_DPD signal is deasserted. It is appreciated, that the core or portion of the integrated circuit in DPD mode may be powered on or awoken prior the deassertion of the E_DPD signal. The pass gates of the level shifters are enabled upon deassertion of the E_DPD signal and thereby electrically couple the inputs of the level shifters to the outputs of the level shifters.

At time 510, the SEL_DPD signal is deasserted. The deassertion of the SEL_DPD signal results in the switching of the inputs to the level shifters from the DPD_value signal to a signal from the portion of the integrated circuit or core previously in DPD mode (e.g., core_value 226). The signal from the core can thereby propagate though the level shifters to the output (e.g., I/O pad 202). In one embodiment, the keeper circuits may be deactivated before the core data arrives at the level shifters. At time 512, the DPD_value signal is deasserted.

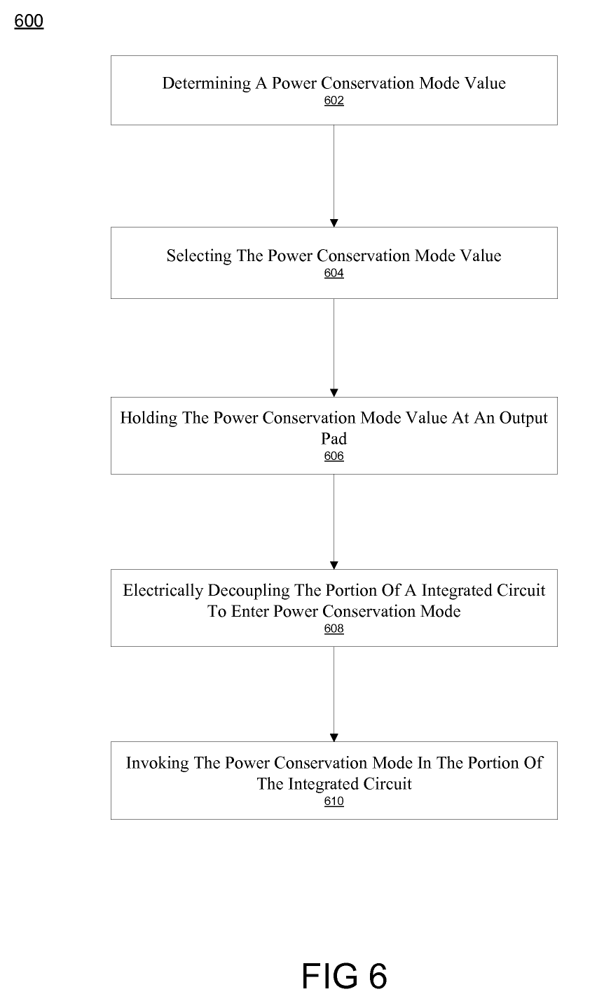

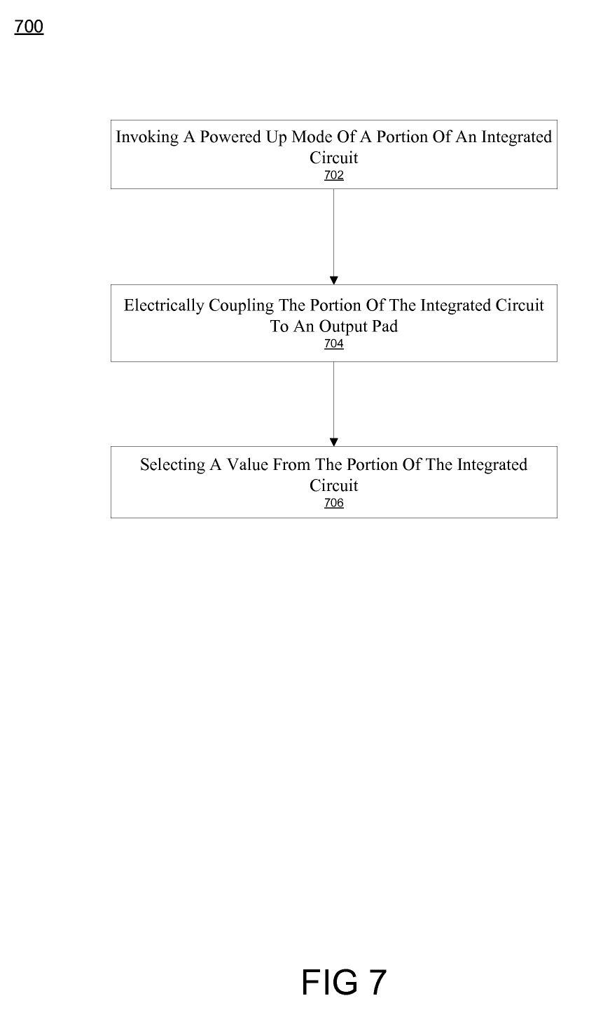

With reference to FIGS. 6 and 7, flowcharts 600 and 700 illustrate example functions used by various embodiments of the present invention for entering and exiting a power conservation mode. Flowcharts 600 and 700 include processes that, in various embodiments, are carried out by hardware. Although specific function blocks (“blocks”) are disclosed in flowcharts 600 and 700, such steps are examples. That is, embodiments are well suited to performing various other blocks or variations of the blocks recited in flowcharts 600 and 700. It is appreciated that the blocks in flowcharts 600 and 700 may be performed in an order different than presented, and that not all of the blocks in flowcharts 600 and 700 may be performed.

FIG. 6 shows a flowchart 600 of a process for entering a power conservation mode in accordance with one embodiment of the present invention. The blocks of flowchart 600 may be carried out by circuits of an integrated circuit (e.g., SoC 102).

At block 602, a power conservation mode value is determined. The power conservation mode value (e.g., DPD_value 216) may be the value or signal to be maintained at an output pad (e.g., I/O pad 202) while a portion of an integrated circuit (e.g., core) is in a power conservation mode (e.g., DPD mode). This value is typically sampled from the core value but held by AO circuits.

At block 604, the power conservation mode value is selected for output. In one embodiment, the power conservation mode is selected via a multiplexer (e.g., multiplexer 224). The selection of the power conservation mode value, allows the power conservation mode value propagate through to the output of the integrated circuit. The output may be a general purpose input/output (GPIO) and operate at a different voltage and/or power domain from the core of an integrated circuit. It is appreciated that the output may be operable to be held in tri-state for the receiving input and may further be coupled to input logic (e.g., input logic 228) for receiving input signals.

At block 606, the power conservation mode value is held at the output pad (e.g., I/O pad 202). As described herein, the power conservation mode value may be held by keeper or clamp circuits and thereby fixing the value of the outputs.

At block 608, the portion of the integrated circuit to enter the power conservation mode are electrically decoupled from the outputs (e.g., I/O pad 202) and the keeper circuits. In one embodiment, the outputs are electrically decoupled, via pass gates (e.g., pass gate transistors 306a and 306b), from the portion of the integrated circuit to enter the power conservation mode. The electrical decoupling of the portion of the integrated circuit to enter the power conservation mode from the outputs prevents glitching on the output.

At block 610, the power conservation mode of a portion of the integrated circuit is invoked. As described herein, the On/Off domain (e.g., the core) may powered down or deactivated and the integrated circuit is now in minimal power consumption state while the outputs are still driven.

FIG. 7 shows a flowchart of a process for exiting a power conservation mode in accordance with one embodiment of the present invention. The blocks of flowchart 700 may be carried out by an integrated circuit (e.g., SoC 102).

At block 702, a powered up mode of a portion of an integrated circuit is invoked. As described herein, a portion of an integrated circuit (e.g., core) may be in an DPD mode and need to be awaken to respond to an input signal.

At block 704, the powered up portion of the integrated circuit is electrically coupled to an output pad. As described herein, the electrical coupling allows the value from the portion of the integrated circuit to be output via an output pad. The electrically coupling may occur via a pass gate and prevents the output from glitching. In one embodiment, the output pad is a general purpose input output (GPIO). The electrical coupling of the output pad allows the output pad to operate at a different voltage from the portion of the integrated circuit. The output pad may further operate in a power domain (e.g., I/O power domain 120) different from the power domain (e.g., on/off domain 122) of an integrated circuit. In one embodiment, the output pad may be operable to be put into tri-state for receiving input.

At block 706, a value from the portion of said integrated circuit is selected. As described herein, the value may be selected via a multiplexer (e.g., multiplexer 224) and may be the value the from the portion of the integrated circuit which entered a powered up mode. The integrated circuit may now fully operate in functional mode and communicate with other circuits, devices, and peripherals coupled to the integrated circuit.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of entering a power conservation mode for an integrated circuit, said method comprising:
determining a power conservation mode value to be maintained at an output pad of said integrated circuit while a portion of said integrated circuit is in said power conservation mode;
propagating said power conservation mode value to said output pad;
electrically decoupling said portion of said integrated circuit from said output pad;
invoking said power conservation mode in said portion of said integrated circuit; and
maintaining said power conservation mode value at said output pad while said portion of said integrated circuit is in said power conservation mode.

2. A method as described in claim 1 wherein said output pad is a general purpose input/output (GPIO).

3. A method as described in claim 1 wherein said output pad operates within a first voltage domain and said portion of said integrated circuit operates within a second voltage domain.

4. A method as described in claim 1 wherein said electrical decoupling comprises decoupling portions of a level shifter circuit using pass gates coupled there between.

5. A method as described in claim 1 wherein said maintaining comprises using keeper circuits to maintain said power conservation mode value at said output pad, wherein said keeper circuits do not enter said power conservation mode.

6. A method as described in claim 1 wherein said electrical decoupling prevents glitching on said output pad as a result of said portion entering and maintaining said power conservation mode.

7. A method as described in claim 1 wherein said output pad is operable to be held in tristate.

8. A method as described in claim 1 wherein said output pad is coupled to a register for receiving input.

9. An integrated circuit comprising:
a first portion operable to enter a power conservation state and for generating a first output signal;
a second portion operable to remain powered during said power conservation state and for generating a second output signal that equals said first output signal;
an output pad; and
a driver circuit for driving a signal over said output pad during said power conservation state, said driver circuit responsive to said first output signal when said first portion is powered and responsive to said second output signal when said first portion is in said power conservation state.

10. An integrated circuit as described in claim 9 wherein said driver circuit comprises:
a selector for selecting between said first output signal and said second output signal;
a level shifter circuit for receiving an output from said selector at a first voltage domain and outputting a signal at a second power domain; and
a pull up/down circuit for receiving said signal at said second power domain and driving said signal over said output pad, wherein said level shifter circuit is also for electrically decoupling said pull up/down circuit from said selector during said power conservation state.

11. An integrated circuit as described in claim 10 wherein said driver circuit further comprises a keeper circuit coupled to an output of said level shifter circuit, said keeper circuit coupled to receive said second output signal and for maintaining an output of said level shifter circuit during said power conservation state.

12. An integrated circuit as described in claim 10 wherein said level shifter circuit comprises:
an input portion operable at said first voltage domain;
an output portion operable at said second voltage domain; and
pass gates coupling said input portion to said output portion and wherein said pass gates perform said electrically decoupling function.

13. An integrated circuit as described in claim 10 wherein said selector is a multiplexer controlled by a select line which indicates when said first portion is within said power conservation mode.

14. An integrated circuit as described in claim 9 wherein said output pad is a general purpose input/output (GPIO) pad.

15. An integrated circuit as described in claim 9 wherein said first portion is a portion of a system on a chip (SoC).

16. A programmable system on a chip (SoC) comprising:
an output;
a driver coupled to said output, said driver comprising:
a pull up circuit coupled to said output;
a pull down circuit coupled to said output;
a plurality of keeper circuits coupled to said pull up circuit and said pull down circuit for maintaining an output signal;
a plurality of level shifter circuits for electrically coupling and decoupling a portion of said SoC to said output;
a plurality of level shifter control circuits coupled to said plurality of level shifter circuits for controlling said electrical coupling and decoupling; and
an output selection circuit coupled to said plurality of level shifter circuits for selecting a signal to output.

17. A SoC as described in claim 16 wherein at least one of said plurality of outputs is a general purpose input output (GPIO).

18. A SoC as described in claim 16 wherein said plurality of level shifter circuits prevent glitching on said respective output during entry and exit of said SoC into a low power mode.

19. A SoC as described in claim 16 wherein said plurality of level shifter circuits bridges a first power domain of said portion of said SoC and a second power domain of said respective output.

20. A SoC as described in claim 19 wherein said output selection circuit selects between an output signal maintained by said portion of said SoC and an output signal maintained by a circuit that remains powered when said portion of said SoC enters a power conservation mode.
